(19) United States
(12) Patent Application Publication
(10) Pub. No.: US 2013/0227790 A1
(43) Pub. Date: Sep. 5, 2013

(54) PORTABLE CONVEYING DEVICE FOR PATIENTS

(71) Applicant: KAERCHER FUTURETECH GMBH, Schwaikheim (DE)

(72) Inventors: Markus Kostron, Remseck (DE); Markus Kurt Saygin, Berlin (DE)

(73) Assignee: Kaercher Futuretech GmbH, Schwaikheim (DE)

(21) Appl. No.: 13/865,476

(22) Filed: Apr. 18, 2013

Related U.S. Application Data
(63) Continuation of application No. PCT/EP2011/067695, filed on Oct. 11, 2011.

(30) Foreign Application Priority Data
Oct. 22, 2010 (DE) 10 2010 050 451.3

(51) Int. Cl. A61G 1/044

(52) U.S. Cl. CPC A61G 1/044
USPC 5/628

(57) ABSTRACT

A stretcher for patients who are heavily soiled or are chemically, biologically or radioactively contaminated. The stretcher comprises a dish-shaped lying arrangement, which extends substantially along a longitudinal direction and has a lying surface for receiving a patient lying substantially along the longitudinal direction. It further comprises a securing arrangement for securing the patient on the lying arrangement and a support frame, which allows the stretcher to be rolled on a ground surface between at least two mechanically stable positions about an axis of rotation arranged parallel to the longitudinal direction. The support frame comprises a first set-down element for setting down the stretcher on the ground surface in a first mechanically stable position, wherein the lying surface is oriented substantially parallel to the ground surface. The support frame further comprises at least one further set-down element for setting down the stretcher on the ground surface in at least one further mechanically stable position, wherein said at least one further mechanically stable position, compared to the first mechanically stable position, is rotated about the axis of rotation, wherein the lying surface is oriented transversely with respect to the ground surface.

### CROSSREFERENCES TO RELATED APPLICATIONS

This application is a continuation of international patent application PCT/EP2011/067695, filed on Oct. 11, 2011 designating the U.S., which international patent application has been published in German language and claims priority from German patent application 10 2010 050 451.3, filed on Oct. 22, 2010. The entire contents of these priority applications are incorporated herein by reference.

### BACKGROUND OF THE INVENTION

The disclosure relates to a portable conveying device for patients. In particular, the disclosure relates to a stretcher for patients who are heavily soiled and/or are chemically, biologically or radioactively contaminated.

Conveying devices of this type are used in particular for rescuing and for removing patients, where the patient has become heavily soiled or even chemically, biologically or radioactively contaminated, for example due to an accident involving a hazardous material. In such cases, there are increased requirements on patient care. On the one hand, it is necessary in most cases for the protection of the patient for said patient to be cleaned or decontaminated in situ. On the other hand, one of the primary requirements in such cases is to avoid a spread of the contaminated area beyond the accident site. In this regard, reference is often made to the need to suppress contamination carry-over as effectively as possible.

With accidents of this type, special conveying devices are therefore necessary, which also perform a multiplicity of further functions in addition to the actual conveying function. For example, the conveying device should allow a patient positioned on the conveying device to be cleaned or decontaminated as easily and thoroughly as possible. Furthermore, it is often necessary to undress the patient as quickly as possible, since the patient's clothing is generally also soiled or contaminated in the aforementioned cases. This process should also take place desirably on the conveying device and not on the ground surface, which is generally also soiled or contaminated. A liquid discharge from the conveying device should be ensured so that it is possible to carry out the cleaning or the decontamination process on the conveying device.

Conventional stretchers or rescue baskets, which are known for example from EP 1 318 782 B1, only meet these requirements in part. With stretchers of this type, the accessibility to a patient placed on the stretcher is often highly restricted, since the patient is normally lying on his back and is fixed rigidly to the stretcher. Medical first-aid treatment and cleaning of the patient, which in particular is necessary directly on-site in the above described case of an accident involving a hazardous material, therefore is generally only possible on an upper side of the patient, mainly on the upper side remote from the lying surface. By contrast, the back or the buttocks can only be cleaned to a limited extent, or this cleaning process requires the patient on the stretcher to be lifted and repositioned. This, again, can often only be ensured with difficulty due to the restricted spatial requirement. The patient can generally also only be undressed awkwardly. This awkward treatment of the patient is also considerably disadvantageous within the context of the avoidance already discussed above of contamination carry-over, since the contact between the helpers and the patient should be kept to a minimum.

### SUMMARY OF THE INVENTION

It is therefore an object to provide a portable conveying device, which is particularly suitable for rescuing heavily soiled and/or chemically, biologically or radioactively contaminated patients, allows increased accessibility to the patient compared to conventional conveying devices of this type, is easy to handle in so doing, and in particular facilitates the care and the possibly necessary decontamination of a patient. In addition, the conveying device to be provided should additionally spare, where possible, unnecessary bodily contact between the helpers and the patient during the treatment process and should take into account the principle of avoiding contamination carry-over.

In view of this object, there is provided a stretcher for patients who are heavily soiled or are chemically, biologically or radioactively contaminated. The stretcher comprises: a bowl-shaped lying arrangement, which extends substantially along a longitudinal direction and has a lying surface for receiving a patient lying substantially along the longitudinal direction; a securing arrangement for securing the patient on the lying arrangement; and a support frame, which is configured to allow the stretcher to be rolled on a ground surface between at least two mechanically stable positions about an axis of rotation arranged parallel to the longitudinal direction. The support frame comprises a first set-down element for setting down the stretcher on the ground surface in a first mechanically stable position, wherein the lying surface is oriented substantially parallel to the ground surface. The support frame further comprises at least one further set-down element for setting down the stretcher on the ground surface in at least one further mechanically stable position, wherein said at least one further mechanically stable position, compared to the first mechanically stable position, is rotated about the axis of rotation, wherein the lying surface is oriented transversely with respect to the ground surface.

According to a further aspect, there is provided a stretcher for patients that comprises: a lying arrangement, which extends substantially along a longitudinal direction and has a lying surface for receiving a patient lying substantially along the longitudinal direction; a securing arrangement for securing the patient on the lying arrangement; a first set-down element, which is configured to allow the stretcher to be set down on a ground surface in a first mechanically stable position, in which the lying surface is oriented substantially parallel to the ground surface; and at least one further set-down element, which is configured to allow the stretcher to be set down on the ground surface in at least one further mechanically stable position, wherein said at least one further mechanically stable position, compared to the first mechanically stable position, is rotated about the longitudinal direction, wherein the lying surface is oriented transversely with respect to the ground surface. The securing arrangement comprises at least one grip for displacing the securing arrangement between an open position, in which the lying arrangement is accessible, and a closed position, in which the securing arrangement secures a patient positioned on the lying surface. Said at least one grip in the open position prevents the stretcher from being rolled, and, in the closed position, forms the at least one further set-down element.

According to a still further aspect, there is provided a portable conveying device for patients that comprises a lying arrangement, which extends substantially along a longitudinal direction and has a lying surface for receiving a patient lying substantially along the longitudinal direction. Said device further comprises a securing arrangement for securing the patient on the lying arrangement. Still further, it comprises a first set-down element, which allows the device to be set down on a ground surface in a first mechanically stable position, wherein the lying surface is oriented substantially parallel to the ground surface; and at least one further set-down element, which allows the device to be set down on the ground surface in at least one further mechanically stable position, which, compared to the first mechanically stable position, is rotated about the longitudinal direction, wherein the lying surface in the at least one further mechanically stable position is oriented transversely with respect to the ground surface.

In contrast to conventional stretchers, the new conveying device can thus be set down on a ground surface not only in one mechanically stable position, but in at least two mechanically stable positions. A “mechanically stable position” is herein to be understood to mean a position of the conveying device/stretcher, in which it can be set down on the ground surface independently and securely, without the need to hold or support the conveying device in order for said device to remain in this position.

Here, the first mechanically stable position corresponds substantially to the conventional position of a stretcher, in which the lying surface, on which the patient is laid, is oriented parallel to the ground surface. The at least one further mechanically stable position of the conveying device by contrast corresponds to a position in which the lying surface is rotated about the longitudinal direction and is oriented transversely with respect to the ground surface. The possibility of orienting the patient transversely with respect to the ground surface in the at least one further mechanically stable position includes the advantage that the patient can be treated in a further spatial position and therefore in a simple manner from a further side.

A patient positioned on the lying surface of the conveying device can thus be easily turned and brought into different positions by setting down the conveying device in various mechanically stable positions. The patient is therefore accessible from different sides. Furthermore, the patient can be brought very easily into the stable side position, without having to contact or lift the patient himself for this purpose. To this end, merely the conveying device per se is turned, whereby the patient secured thereon is also turned. Since the conveying device, including the patient, is oriented transversely with respect to the ground surface, the back or the buttocks of the patient for example can also be cleaned more easily or treated directly on the conveying device. The patient can also be undressed in a considerably facilitated manner due to the simple possibility of turning the conveying device or the patient.

In particular in the above-described case of an accident involving a hazardous material, the presented conveying device is therefore advantageous. The patient only has to be directly contacted once in order to be positioned on the conveying device. If the patient then has to be cleaned or decontaminated, he no longer has to be repositioned a number of times, that is to say turned on the support itself, in contrast to conventional stretchers, but can be turned together with the entire stretcher device. The helpers merely have to contact the portable conveying device for this purpose in order to rotate said device about the longitudinal axis thereof and to set down the device in one of the at least two mechanically stable positions.

Due to the possibility of turning the conveying device, the accessibility to the patient also increases, which in turn simplifies cleaning of the patient. In the case of a chemical, biological or radioactive contamination, the patient is generally cleaned by being sprayed with disinfectant or water. In many cases, it also attempted to blot the patient with the aid of a liquid-absorbing rescue sheet in order to relieve him of his contaminations. This can also be ensured more easily by the simple possibility of turning the conveying device. Here, it is particularly advantageous that the patient can be set down in various positions in a mechanically stable manner. Specifically, this also means that the helpers have their hands free when the patient or the conveying device is set down in a mechanically stable position, since both the conveying device and the patient are positioned or laid reliably in each of the at least two mechanically stable positions. It is not necessary to hold or support the conveying device or the patient. The presented conveying device is therefore suitable as a steady treatment station in the vicinity of the accident site. This in turn provides considerable advantages in the sequence of operations and reduces the usage time, which is often crucial. The number of helpers that are required for such a use can thus also be considerably reduced. This is particularly the case with uses with which the helpers have to wear personal protective equipment.

When turning the conveying device about the longitudinal axis thereof, the patient is secured by a securing arrangement. This prevents the patient from falling out from the lying arrangement. Securing arrangements of this type can be designed in a wide range of manners. It is merely important that the securing arrangement secures the patient in the best possible way on the conveying device, even when said patient is rotated about the longitudinal direction, together with the conveying device. For example, a plurality of gripper elements or belts, which encompass the patient are conceivable. However, a securing mesh or securing net would also be conceivable, which is stretched over the lying arrangement. It should merely be ensured that the patient is not fixed absolutely rigidly on the lying arrangement, but that there is a specific play between the securing arrangement and the patient. The patient is thus easily movable on the lying arrangement in each of the at least two mechanically stable positions of the conveying device and is therefore in turn more accessible for the helpers.

It goes without saying that the portable conveying device can be used not only for conveying people, but can also convey any type of material. For example, the helpers may also convey on the conveying device the necessary implements, such as medical devices or other necessary equipment, on the way from and to the accident site.

A further advantageous property of the presented conveying device is the easy conveyability thereof and the simple operation thereof. It is therefore also suitable for use in rough terrain. Although the portable and mobile properties of the presented conveying device constitute a key feature of the present invention for the above-cited reasons, a stationary use of the conveying device is also thoroughly conceivable however.

In a refinement, the conveying device comprises foldable carry grips. This further improves the conveyability of the device. These grips can be folded out and locked in order to carry the conveying device on this basis or to turn the conveying device about the longitudinal direction thereof in the above-described manner. If, by contrast, the carry grips are not required, these can be folded in so as to thus reduce the space consumed by the conveying device.

In accordance with a further refinement, at least two eyelets are provided on the conveying device, which are suitable for rope or helicopter rescue. Onward transport, for example by the helicopter, is also ensured in this manner.

In a further refinement, the lying arrangement has a plurality of openings.

This embodiment is advantageous in particular because the patient is then accessible for the helpers from the rear side of the lying arrangement through the openings. If the portable conveying device is set down in the at least one further mechanically stable position, which is rotated about the longitudinal direction compared to the first mechanically stable position, and in which the lying surface is oriented transversely to the ground surface, the patient positioned on the lying surface can thus be cleaned or directly treated easily from the rear side of the lying arrangement.

Since the patient is generally positioned on his back on the lying surface, the accessibility to the patient's back and buttocks is increased immensely by the aforesaid openings in the lying arrangement. For example, the patient can thus be cleaned firstly in the first mechanically stable position on his upper side (face, front torso and front side of the legs and feet) and can then also be cleaned from his rear side (back and buttocks) in the at least one further mechanically stable position by simply turning the conveying device about the longitudinal direction thereof.

Since, in particular in the case of chemically, biologically or radioactively contaminated patients, a very large amount of decontamination liquid is necessary in order to clean the patient, the openings in the lying arrangement have proven to be additionally advantageous. Specifically, the cleaning liquid can thus drain away very easily through the openings and does not remain within the conveying device. The hazardous materials, such as chemicals or poisons, with which the patient is contaminated in such cases can also drain away through the openings. The patient can therefore already be relieved in situ of the hazardous materials, without any of the hazardous materials remaining within the conveying device and being carried over when the patient is transported away. The objective of avoiding contamination carry-over is thus accommodated as best as possible.

The openings themselves can be embodied in a wide range of forms. Provided it is ensured that the patient can lie on the lying surface, the lying arrangement may also be interrupted over a large area. A net as a lying arrangement would also be conceivable. The greater the aforementioned openings in the lying arrangement, the greater is the accessibility to the patient from the rear side of the lying arrangement, and the better a cleaning liquid possibly used or hazardous materials that may be present can drain away from the conveying device.

In a still further embodiment, the portable conveying device has a support frame, which allows the portable conveying device to be rolled on the ground surface between the at least two mechanically stable positions about an axis of rotation parallel to the longitudinal direction.

This embodiment has proven to be advantageous above all with heavy patients. Due to the aforementioned support frame, the conveying device can specifically be rolled very easily about the longitudinal axis thereof from one mechanically stable position into the at least one further mechanically stable position and vice versa. It is thus no longer necessary to lift the conveying device, including the patient positioned therein, in order to change from one mechanically stable position into another mechanically stable position.

Due to the aforementioned rolling possibility, jerky movements can also be avoided, which in particular benefits the safety of the patient. The application of force necessary to turn the conveying device or the patient positioned thereon is also considerably reduced by the rolling possibility.

The word “support frame” is to be understood very broadly. It is understood to include any type of outer sleeve or shell of the portable conveying device, on which the conveying device can be set down in a first mechanically stable position, in which the lying surface is oriented substantially parallel to the ground surface, and, by rolling about the longitudinal direction, can be brought into at least one further mechanically stable position, in which the conveying device can be set down in such a way that the lying surface is oriented transversely to the ground surface.

In order to enable the rolling option, the support frame is preferably formed in a dimensionally stable manner. Depending on the type and shape of the support frame, the axis of rotation may or may not coincide with the longitudinal axis of the conveying device. The axis of rotation is, however, at least parallel to the longitudinal direction of the conveying device.

In accordance with a further refinement, the support frame defines at least one curved surface portion, which is curved about the axis of rotation and which allows the portable conveying device to be rolled.

The possibility of rolling the portable conveying device on the ground surface is thus implemented in a very simple manner by a curved surface portion, which is defined by the support frame. This is possible for example by one or more struts arranged transversely to the longitudinal direction of the conveying device, which are curved about the longitudinal direction. These, attached to the outer face of the conveying device, span a curved rolling plane, via which the conveying device can be rolled on the ground surface. In principle, it is also possible for the curved surface portion to be formed directly, that is to say over the entire area, by the frame, for example by an at least partly curved outer wall.

In a further refinement, the support frame defines at least two planar surface portions, wherein a first planar surface portion is oriented parallel to the lying surface and forms the first set-down element, and wherein a second planar surface portion is oriented transversely to the lying surface and forms the at least one further set-down element.

In accordance with this embodiment, the support frame thus defines at least two planar surface portions, which form the set-down elements, with the aid of which the conveying device can be set down in the at least two aforementioned mechanically stable positions. In the first mechanically stable position, the conveying device lies on the ground surface via the first planar surface portion, which is oriented parallel to the lying surface. By contrast, in the at least one further mechanically stable position, the conveying device lies on the ground surface on the at least one further planar surface portion, which is oriented transversely to the lying surface.

Similarly to the above-mentioned curved surface portion, the at least two planar surface portions can be provided for example by one or more struts arranged transversely to the longitudinal direction, which are attached to the outer face of the conveying device and provide a secure position for the conveying device. Here, it is also conceivable however for the support frame to have two surface portions that are planar over the entire area, for example two planar walls, on which the conveying device can be set down in a mechanically stable manner.

In a further refinement, the at least one curved surface portion and the at least two planar surface portions define the outer sleeve of the portable conveying device, wherein the lying surface is positioned within the outer sleeve and is spaced therefrom.

Since the lying surface is positioned within the outer sleeve and is spaced therefrom, there is always a specific clearance between the lying surface and the ground surface, irrespective of the position of the conveying device. A patient positioned on the lying surface is therefore not in direct contact with the ground surface in any position. This is advantageous in particular in the event of accidents involving a hazardous material, since the patient therefore does not come into contact with the ground surface at the accident site, said ground surface often being heavily soiled or contaminated. Even if the conveying device is set down directly on the ground surface, the patient is always arranged at a sufficiently large distance from the ground surface.

This not only promotes the safety of the patient, but also facilitates cleaning of the patient, since the cleaning liquid can drain away through openings in the lying arrangement and then over the ground surface, and the patient is then no longer in contact therewith, let alone lying in the pool of chemicals and washing liquid located on the ground surface. This has also proven to be advantageous from the viewpoint of avoiding contamination carry-over.

It should also be mentioned that the above-defined “outer sleeve” is not necessarily to be understood to mean a closed outer sleeve. The support frame may just as well form an open structure, for example by means of a plurality of struts spaced from one another.

In a further refinement, the portable conveying device with a patient positioned on the lying surface, depending on the body weight of said patient, has an overall center of gravity arranged in the region of the axis of rotation.

The term “overall center of gravity” is to be understood to mean the resultant center of gravity of the overall system, which consists of the conveying device and the patient positioned on the lying surface. This overall center of gravity depends on the one hand on the center of gravity of the conveying device itself, and also on the center of gravity of the patient positioned on the lying surface. Depending on the body size and body weight of the patient, the center of gravity of the body is different from patient to patient. By means of a suitable arrangement of the lying surface and by means of suitable dimensioning of the conveying device, the overall center of gravity of the system can be brought relatively accurately into a predetermined position however. Here, it is particularly advantageous if the dimensions of the conveying device are selected in such a way that the overall center of gravity comes to lie in the region of the axis of rotation. In this case, minimal imbalance is thus achieved specifically, and therefore a patient positioned on the lying surface can be turned or rolled about the longitudinal direction of the conveying device with minimal application of force.

In a further refinement, the at least one further set-down element includes a second and a third set-down element, wherein the second set-down element allows the device to be set down on the ground surface in a second mechanically stable position, and the third set-down element allows the device to be set down on the ground surface in a third mechanically stable position, wherein the second and the third mechanically stable position are each rotated in an opposite direction about the longitudinal direction compared to the first mechanically stable position, wherein the lying surface is preferably oriented in each case perpendicularly with respect to the ground surface.

In accordance with this refinement, the conveying device thus has three mechanically stable positions. The first mechanically stable position, in which the lying surface is oriented parallel to the ground surface, corresponds substantially to the position of a conventional stretcher. The second and the third mechanically stable position are rotated by 90° in the clockwise direction or in the anticlockwise direction respectively compared to the first mechanically stable position.

The patient can thus be positioned initially on the lying surface in the first mechanically stable position and can then be brought into the second or into the third mechanically stable position by turning about the longitudinal direction. In the second and third mechanically stable position, the patient is secured on the lying arrangement from falling out by means of the securing arrangement already described. Since the patient can be brought into three different mechanically stable positions, he can be treated or cleaned particularly well. By turning the conveying device and therefore also the patient by 90° in each case, all body regions of the patient are accessible for the helpers.

In a further refinement, the lying device is dish- or bowl-shaped and has side walls, which are oriented transversely to the lying surface.

A bowl-shaped embodiment of the lying arrangement has the advantage that the side walls are used as additional lying surfaces in the above-described second and third mechanically stable positions. If the conveying device is turned or rolled through 90° about its longitudinal direction, the patient thus lies on one of these side walls via his right-hand or left-hand body side and is held by said side walls. A dish-shaped conveying device therefore holds the patient on the lying arrangement in the best possible manner.

In a further refinement, the securing arrangement has an open position making the lying arrangement accessible, and a closed position, in which the securing arrangement holds a patient positioned on the lying surface with defined play.

In the open position, in which the lying arrangement is accessible, the patient can be positioned on the lying surface. The securing arrangement can then be closed so that the patient is secured on the lying arrangement. The defined play between the securing arrangement and the patient positioned on the lying surface ensures easy movability of the patient within the lying arrangement. This in turn increases the accessibility to the patient, since the helpers can easily move the patient within the lying arrangement, irrespective of the mechanically stable position in which the conveying device is located. In contrast to conventional stretchers, the patient therefore is not fixed rigidly, but is mounted movably within the lying arrangement.

In a further refinement, the securing arrangement is mounted in a foldable or displaceable manner and can be folded or displaced between the open and the closed position via grips arranged on said securing arrangement.

The securing arrangement can thus be brought very easily from the open position into the closed position, or vice versa can also be brought from the closed position into the open position. A foldable or displaceable mechanism also has the advantage that operating errors are largely ruled out, since the two positions (the open position and the closed position) are mechanically predefined. The helpers can thus position the patient on the lying surface in the open position and can then secure the patient on the lying arrangement by simply folding down or displacing the securing arrangement. A folding or displacement mechanism of this type has also proven to be very robust. In contrast to belts, which are often used with conventional stretchers to secure the patient, an awkward closure of the belts on account of buckles is spared with the securing arrangement.

In a further refinement, the grips in the open position prevent the portable conveying device from rolling, and in the closed position form the at least one further set-down element.

Since the grips in the open position prevent the portable conveying device from rolling, the portable conveying device can only be rolled on the ground surface when the securing arrangement is closed and the patient is secured on the lying arrangement. This prevents the helpers from attempting to turn the conveying device, together with the patient positioned thereon, if said patient is not secured.

To this end, the grips are preferably arranged in the open position of the securing arrangement in such a way that the curved surface portion, which is defined by the support frame and enables the portable conveying device to be rolled, is interrupted. This can be implemented for example as a result of the fact that the grips in the open position of the securing arrangement form the first set-down element, which allows the conveying device to be set down on the ground surface in the first mechanically stable position, and, in the closed position of the securing arrangement, form the at least one further set-down element, which allows the device to be set down on the ground surface in the at least one further mechanically stable position.

The conveying device can be prevented from rolling in the open position of the securing arrangement in a wide range of manners. For example, it is conceivable that the conveying device can only be grasped at the grips in order to be turned, or that the grips are only accessible for the helpers when the securing arrangement is located in the closed position.

In a further refinement, the securing arrangement has a plurality of resilient retaining elements, which are spaced from one another in the longitudinal direction and which have different sizes, at least in part.

Resilient retaining elements of this type are preferably designed in the form of clips or grippers. They enclose a patient positioned on the lying surface, at least in part, and thus act similarly to individual hands, which secure the patient in the at least one mechanically stable position, in which the lying surface is oriented transversely to the ground surface. The helpers themselves therefore no longer have to hold the patient when the conveying device is turned about its longitudinal axis and the lying surface, including the patient position thereon, is therefore rotated about the longitudinal direction.

The resilience of the individual retaining elements has proven to be advantageous in many respects. On the one hand, the patient is thus retained resiliently, which increases the comfort of the patient. On the other hand, an increased movability of the patient within the lying arrangement is in turn provided as a result of the resilience, and therefore said patient can move or shift easily within the lying arrangement. As already described above, this facilitates the accessibility to the patient and provides the possibility of treating or cleaning the patient as best as possible from all body sides.

Furthermore, it has proven to be advantageous if the retaining elements are formed in different sizes. In particular in the head region or in the foot region of the patient, the retaining elements are preferably shorter in order to avoid pinching the patient. On the other hand, this again increases the accessibility to the patient in these body regions.

Since the resilient retaining elements are spaced from one another in the longitudinal direction, clearances are additionally provided between the retaining elements, through which the helpers can reach in order to treat or clean the patient.

In accordance with a further refinement, the retaining elements have a plurality of openings. These openings perform a similar function to the openings in the lying arrangement already described above. On the one hand, they additionally increase the accessibility to the patient positioned on the lying surface. On the other hand, the liquid used when cleaning the patient can reach the patient more easily through these openings and can then also drain away again from the conveying device.

In a further refinement, the portable conveying device has an undercarriage with at least one wheel or a castor arranged thereon, wherein the undercarriage is arranged foldably on the lying arrangement.

An undercarriage of this type in particular facilitates the transport away from the accident site, since the conveying device does not have to be carried, but can also be wheeled. Here, it is particularly preferable for the undercarriage to be attached releasably to the conveying device, such that said undercarriage is only attached when actually necessary. For example, a quick-locking mechanism of simple mechanical design for attachment and removal of the undercarriage is conceivable on the conveying device.

Furthermore, it is preferable if the undercarriage can be locked in the folded-out position. In order to ensure maximum stability when wheeling the conveying device, it is particularly preferable in this case for the undercarriage to be attached in the region of the center of gravity of the conveying device.

The foldable undercarriage thus provides the helpers with the possibility of easily transporting a patient positioned on the lying surface of the conveying device away from the accident site by means of wheeling and then of stowing the conveying device, including the patient, in the ambulance by collapsing the undercarriage.

Here, it is particularly preferable if the undercarriage is designed in such a way that the conveying device can be wheeled both when the undercarriage is collapsed and when the undercarriage is folded out. This is possible, for example, since the castors are arranged at an end face of the conveying device when the undercarriage is collapsed and protrude slightly beyond the outer edge of the conveying device, such that the castors are in contact with the ground surface when the conveying device is deposited. By lifting at the opposite end of the conveying device, said device can therefore also be wheeled when the undercarriage is collapsed.

It goes without saying that the features mentioned above and the features yet to be explained hereinafter can be used not only in the respective combination specified, but also in other combinations or in isolation, without departing from the scope of the present disclosure.

### BRIEF DESCRIPTION OF THE DRAWINGS

Exemplary embodiments are illustrated in the drawings and will be explained in greater detail in the following description. In the drawings:

FIG. 1 shows a perspective view of a first exemplary embodiment of the portable conveying device for patients, wherein a securing arrangement intended to secure the patient is located in an open position;

FIG. 2 shows a perspective view of the first exemplary embodiment from FIG. 1, wherein the securing arrangement for securing the patient is located in a closed position;

FIG. 3 shows a schematic front view of the first exemplary embodiment from FIGS. 1 and 2, with a patient inserted into the portable conveying device, wherein the portable conveying device is located in a first mechanically stable position;

FIG. 4 shows a schematic front view of the first exemplary embodiment from FIGS. 1 and 2, with a patient inserted into the new portable conveying device, wherein the portable conveying device is located in a second mechanically stable position;

FIG. 5 shows a side view of the first exemplary embodiment from FIGS. 1 and 2, wherein the securing arrangement intended to secure the patient is located in the closed position;

FIG. 6 shows a plan view of the first exemplary embodiment from FIGS. 1 and 2 from the upper side of the new portable conveying device;

FIG. 7 shows a perspective view of a second exemplary embodiment of the portable conveying device for patients with an undercarriage arranged thereon, which is in a folded-out position; and

FIG. 8 shows a perspective view of the second exemplary embodiment from FIG. 7, wherein the undercarriage is located in a collapsed position.

### DESCRIPTION OF PREFERRED EMBODIMENTS

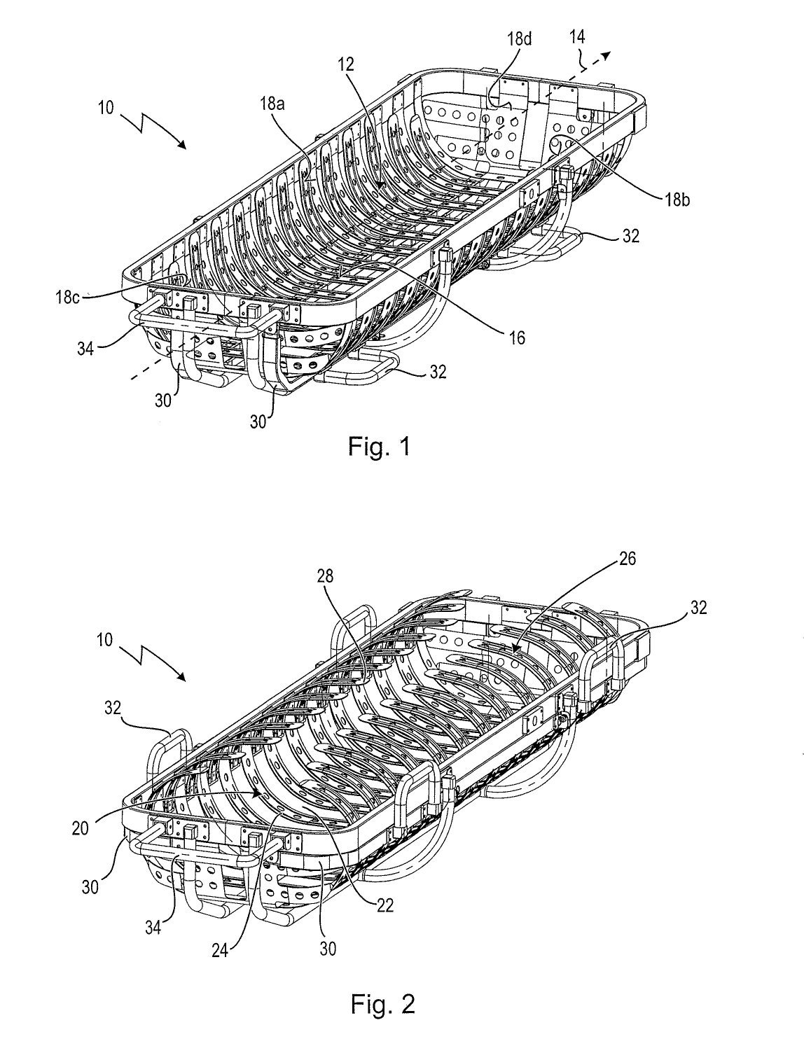

FIGS. 1 and 2 each show a perspective view of a first exemplary embodiment of the portable conveying device for patients. In these figures, the portable conveying device is denoted in its entirety by the reference numeral 10. The portable conveying device 10 has a lying arrangement 12, which extends substantially along a longitudinal direction 14. The lying arrangement 12 defines a lying surface 16, which is suitable for receiving a patient lying substantially along the longitudinal direction 14. The lying device 12 itself is substantially dish- or bowl-shaped in this exemplary embodiment. It has a plurality of side walls 18a, 18b, 18c, 18d, which are oriented transversely to the lying surface 16.

In the exemplary embodiment, the lying arrangement 12 has a partly open or interrupted structure. As can be seen in particular from FIG. 2, the lying arrangement 12 is formed by a plurality of support elements 20 spaced from one another in the longitudinal direction 14. The lying device 12 thus has a plurality of openings 22 in the gaps between the support elements 20. Further openings 24 are provided in the support elements 20 themselves in accordance with this exemplary embodiment. These may be provided for example in the form of regular holes or through-holes.

Furthermore, the portable conveying device 10 has a securing arrangement 26, which, in accordance with this embodiment, includes a plurality of resilient retaining elements 28 spaced from one another in the longitudinal direction 14. The securing arrangement 26 is used to secure the patient on the lying arrangement 12 and thus prevents the patient from falling out from the portable conveying device 10. The securing arrangement 26 is mounted so as to be foldable or displaceable and can therefore be folded or displaced between an open position making the lying arrangement 12 accessible, and a closed position.

In the view shown in FIG. 1, the securing arrangement 26 is located in the open position, in which the lying arrangement 12 is accessible so that a patient can be positioned on the lying surface 16. By contrast, FIG. 2 shows the securing arrangement 26 in the closed position, in which the securing arrangement 26 holds a patient positioned on the lying surface with defined play. To this end, the retaining elements 28 enclose the patient, at least in part, positioned on the lying surface 16.

The mentioned folding mechanism of the securing arrangement 26 is provided in the embodiment shown via folding clips 30, which are connected to the retaining elements 28 and are mounted on the conveying device 10 foldably about the longitudinal direction 14. For improved handling, these folding clips 30 have a plurality of grips arranged thereon, on account of which a user can very easily displace the securing arrangement 26 or the retaining elements 28 in and out between the open position (see FIG. 1) and the closed position (see FIG. 2).

In order to further facilitate the conveyability of the conveying device 10, the conveying device 10 in the embodiment shown has further carry grips 34 on the outer face of the side walls 18c and 18d arranged at each end in the longitudinal direction 14, said further carry grips being foldable. These can thus be folded out as required for carrying purposes, or can be folded in so as to save space.

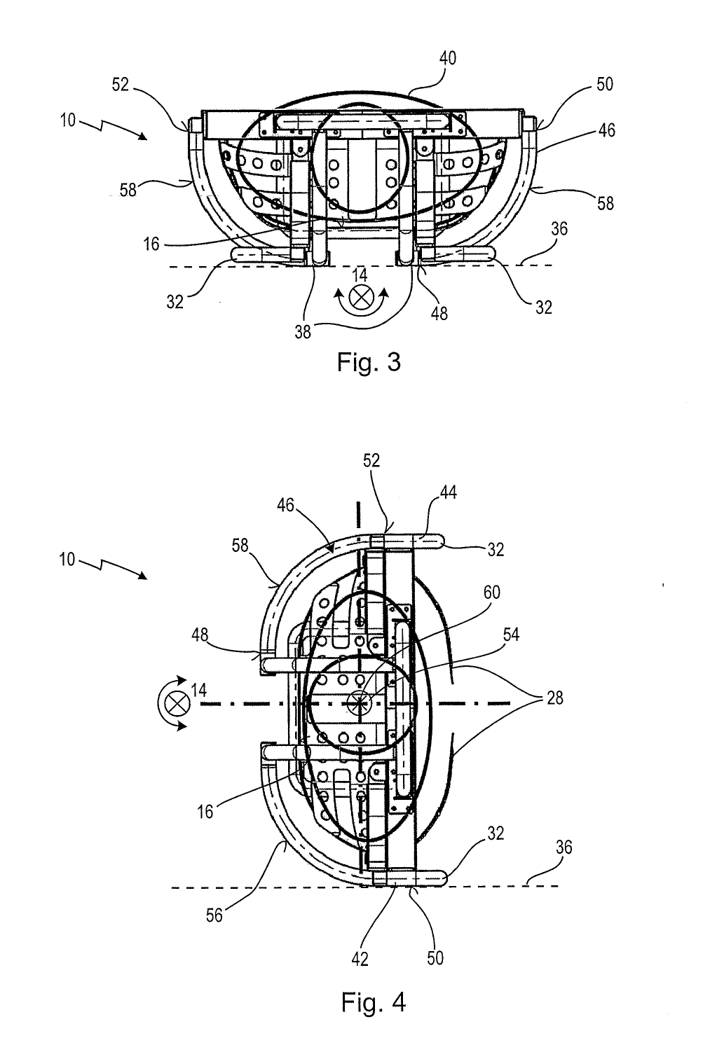

The operating principle of the conveying device 10 can be seen most clearly in the schematic front views shown in FIGS. 3 and 4. By comparing these two figures, it can be seen that the conveying device 10 can be set down on a ground surface 36 (indicated here in a dashed manner) in a number of mechanically stable positions. A first set-down element 38 allows the conveying device 10 to be set down on the ground surface 36 in a first mechanically stable position, as shown in FIG. 3. In this first mechanically stable position, the lying surface 16 is oriented substantially parallel to the ground surface 36.

The first mechanically stable position of the conveying device shown in FIG. 3 therefore corresponds substantially to the position with which a conventional stretcher, as is already known in a wide range of forms from the prior art, is set down on a ground surface. In this position, a patient 40 indicated here schematically can be positioned on the lying surface 16 with the securing arrangement 26 open. In practice, the patient 40 is preferably laid on his back on the lying surface 16.

A second and a third set-down element 42, 44, which are likewise attached to the conveying device 10, also allow the device to be set down on the ground surface 36 in further mechanically stable positions, in contrast to conventional stretchers. Enabled by the second set-down element 42, the conveying device 10 can be set down on the ground surface 36 specifically in a second mechanically stable position, in which the lying surface 16 is oriented transversely, or, as shown in FIG. 4, perpendicularly with respect to the ground surface 36. Compared to the first mechanically stable position shown in FIG. 3, the conveying device 10 is rotated about the longitudinal direction 14 in a clockwise direction in the second mechanically stable position shown in FIG. 4.

As can likewise be seen from FIG. 4, in accordance with the shown embodiment the conveying device 10 can also be rotated in an counterclockwise direction about the longitudinal direction 14 from the first mechanically stable position (see FIG. 3) and can be set down on the ground surface 36 on the third set-down element 44 in a third mechanically stable position. In this third mechanically stable position too, which is not illustrated here again explicitly, the lying surface 16 is oriented transversely or preferably perpendicularly with respect to the ground surface 36.

It goes without saying that the conveying device 10 may similarly include alternative or further set-down elements, which allow the conveying device 10 to be set down in further mechanically stable positions, in which the lying surface 16 encloses an arbitrary angle with the ground surface 36 (for example 20°, 30° or 45°).

The conveying device 10 can thus be set down on a ground surface 36 in a number of mechanically stable positions. This has proven to be particularly advantageous, since a patient 40 positioned on the lying surface 16, and also the conveying device 10, can therefore be turned very easily and is very effectively accessible from a number of sides in the different mechanically stable positions. The patient 40 himself no longer has to be contacted for turning, which has proven to be advantageous, in particular in the above-described case of an accident involving a hazardous material, if the patient 40 is heavily soiled or even chemically, biologically or radioactively contaminated. In the various mechanically stable positions, the patient 40 can be cleaned or treated from different sides. This is very important in particular in view of the necessary avoidance of contamination carry-over, because the patient 40 should already be cleaned or decontaminated as fully as possible in situ (at the accident site) in order to prevent carry-over of the contaminated substances from the accident site.

The above-mentioned set-down elements 38, 42, 44, which allow the conveying device 10 to be set down in the various mechanically stable positions, are formed substantially by a support frame 46, which is attached to the outer face of the conveying device 10 and surrounds said conveying device at least in part. In accordance with the present embodiment, this support frame 46 defines three planar surface portions 48, 50, 52 and two surface portions 56, 58 curved about an axis of rotation 54. Here, the described axis of rotation 54 is parallel to the longitudinal direction 14.

The first planar surface portion 48 is oriented parallel with respect to the lying surface 16 and forms the first set-down element 38, which allows the conveying device 10 to be set down on the ground surface 36 in the first mechanically stable position. The second and the third planar surface portion 50, 52 are oriented transversely, or, in this embodiment, perpendicularly with respect to the lying surface 16. They form the already described second and third set-down elements 42, 44, which allow the conveying device 10 to be set down in the second and third mechanically stable position respectively. The two surface portions 56, 58 curved about the axis of rotation 54 are used as a type of rolling arrangement, which allows the conveying device to be rolled on the ground surface 36 about the axis of rotation 54 between the three described mechanically stable positions. This rolling process has proven to be particularly advantageous, in particular with heavy patients, since the conveying device 10 does not have to be lifted from the ground surface 36 in order to be turned, but can be rolled directly on the ground surface. This considerably reduces the application of force to be applied in order to turn the conveying device 10.

In order to further facilitate the rolling of the conveying device 10, it is particularly preferable here for the dimensions of the conveying device 10 or of the support frame 46 to be selected in such a way that the overall center of gravity 60 of the system formed of patient and conveying device, said overall center of gravity resulting from the center of gravity of the patient 40 and the center of gravity of the conveying device 10, comes to lie in the region of the axis of rotation 54. This avoids an imbalance when turning the conveying device and accordingly facilitates the turning process.

A further property of the conveying device 10 can also be seen from FIGS. 3 and 4. The above-mentioned grips 32 specifically not only perform the function already described of switching or folding the securing arrangement 26 from the open position into the closed position. In the open position, they additionally prevent the conveying device from rolling and, in the closed position, form the second and third set-down elements 42, 44.

In the open position of the securing arrangement 26, the grips prevent the conveying device 10 from rolling by lengthening the first planar surface portion 48, which is defined by the support frame 46, and thus serving as an additional supporting leg in the first mechanically stable position. In the closed position of the securing arrangement 26, the outer faces of the grips 32 by contrast lengthen the second and the third planar surface portion 50, 52 of the support frame 46, whereby they form the second and the third set-down element 42, 44, at least in part.

Since the grips 32 in the open position of the securing arrangement 26 prevent the conveying device from rolling and therefore from being turned about the longitudinal direction 14 or about the axis of rotation 54, the conveying device can only be turned or rolled in the closed position of the securing arrangement 26. This is particularly advantageous for safety reasons, since the conveying device 10 can only be turned or rolled on the ground surface 36 when the securing arrangement 26 is closed and the patient is therefore secured from falling out.

A further advantage of the constructional embodiment of the securing arrangement 26 is provided as a result of the fact that the retaining elements 28 used to secure the patient 40 are resilient and hold the patient 40 with defined play. If the conveying arrangement 10, including the patient 40, is turned, the patient 40 can thus by tilted slightly forward in the second or third mechanically stable position until he contacts the retaining elements 28 and is retained thereby. Due to the openings 22 in the lying arrangement 12, the patient 40 is then very easily accessible from his rear side. He can also move slightly in the lying arrangement 12, which considerably facilitates the treatment of the patient 40. The patient 40 can thus also be undressed more easily than if the patient 40 is fixed rigidly within the lying arrangement 12.

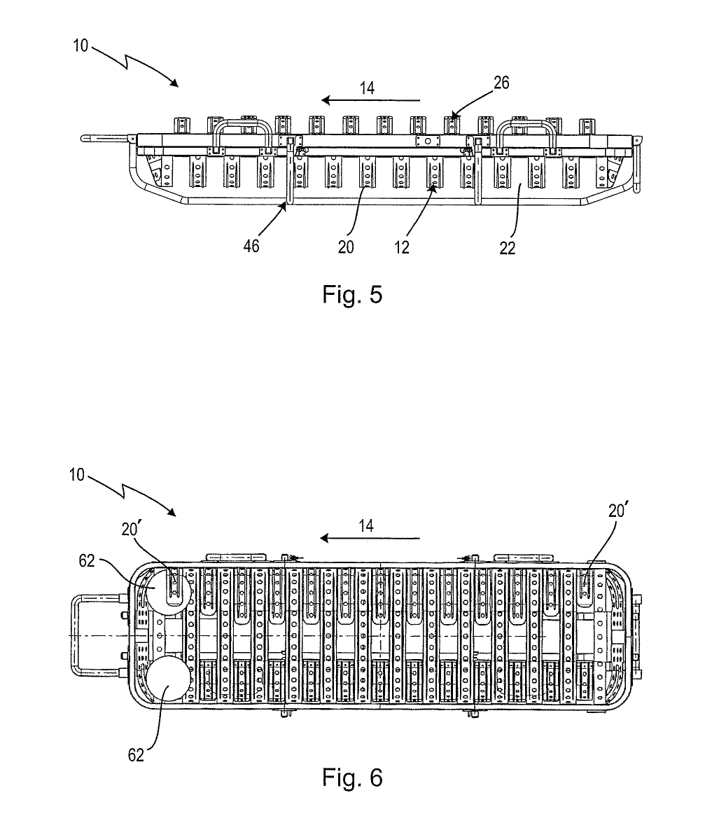

FIG. 5 shows a side view of the first embodiment of the portable conveying device 10. In particular, the constructional design of the support frame 46 and the design of the lying arrangement 12 and securing arrangement 26 can again be seen particularly well in this figure. The securing arrangement 26 is located in this view in the closed position. It can likewise be seen that the individual support elements 20, which form the lying arrangement 12, are spaced relatively far from one another. The openings 22, which are produced in the gaps, are preferably of such a size that the helpers can contact the patient with their hands through these openings. It can also be seen from FIG. 5 that the support elements 20 and therefore the lying arrangement 12 are surrounded by the support frame 46 and spaced therefrom. This provides the advantage that a patient positioned on the lying surface 16 is always arranged at a specific distance from the ground surface, irrespective of the mechanically stable position in which the conveying device is set down on the ground surface 36. This is advantageous in particular in cases in which the ground surface 36 is heavily soiled or contaminated.

FIG. 6 shows the portable conveying device 10 again in plan view from its upper side. In this view, it can be clearly seen that the support elements 20′ in the patient's head region and foot region are each shorter. This shorter embodiment of the support elements 20′ is intended to prevent pinching of the patient and to increase the accessibility to the patient's face. In this figure, the securing arrangement 26 is closed on one side and open on the other side. Furthermore, two head rests 62 can be seen in FIG. 6, which are arranged within the lying arrangement 12. These help to stabilize the patient's head.

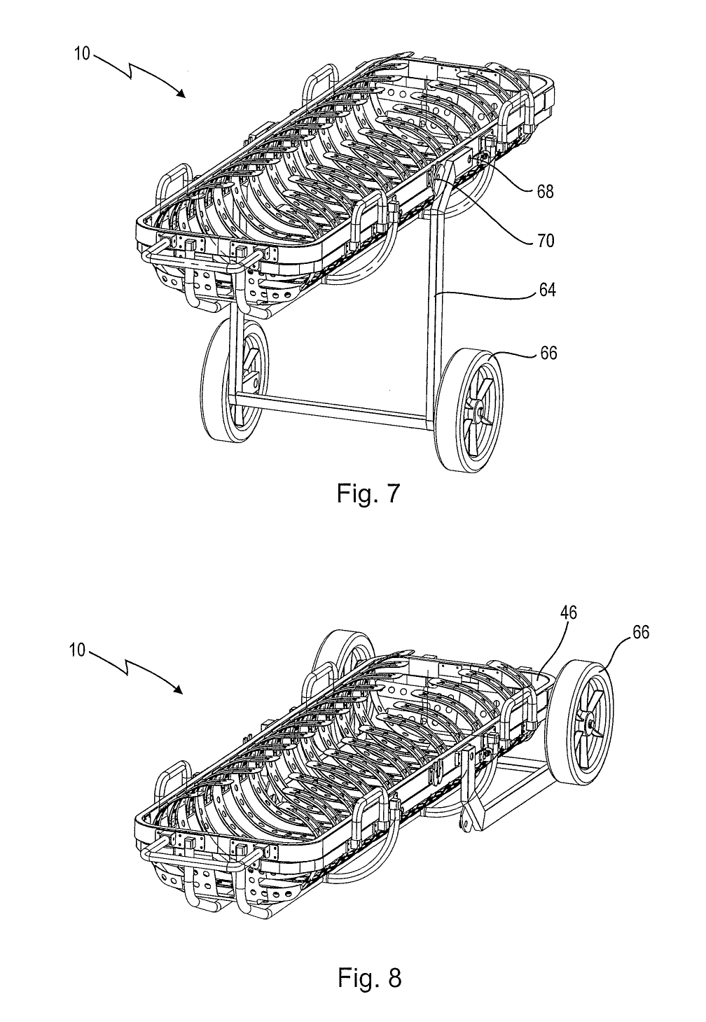

FIGS. 7 and 8 each show perspective views of a second embodiment of the conveying device 10. This second embodiment basically differs from the first embodiment by an undercarriage 64, which is attached foldably to the conveying device 10. In the embodiment shown, the undercarriage 64 is formed with a single axle with two wheels 66 arranged thereon. It goes without saying however that a multi-axle undercarriage with a plurality of wheels or castors is also conceivable.

To this end, the undercarriage 64 can preferably be fastened to the conveying device 10 by means of a quick-acting closure 68 so that it can be easily assembled as required. Furthermore, a lock 70 is provided, which allows the undercarriage 64 to be locked in the folded-out state.

The foldable undercarriage 64 thus provides the helpers with the possibility of easily transporting a patient positioned on the lying surface 16 away from the accident site by means of wheeling and then stowing the conveying device 10, including the patient, in an ambulance by collapsing the undercarriage 64.

As is shown in FIG. 8, the undercarriage 64 is designed in such a way that the conveying device 10 can be wheeled, even when the undercarriage 64 has been collapsed. The wheels 66 are arranged at one end of the conveying device 10 once the undercarriage 64 has been collapsed and protrude slightly beyond the outer edge of the support frame 46 of the conveying device 10 so that the wheels 66 are in contact with the ground surface when the conveying device is deposited. By lifting the conveying device 10 by means of the carry grip 34 arranged at the opposite end, the conveying device can thus also be wheeled in the collapsed state of the undercarriage 64.

To summarize, it can thus be found that the presented portable conveying device has a high level of mobility and, due to its robust design, allows versatile use, even in rough terrain. The new conveying device has proven to be advantageous in particular in the event of accidents involving a hazardous material, in which the patient is heavily soiled or chemically, biologically or radioactively contaminated. Due to the simple turning possibility and the possibility for setting down the conveying device on a ground surface in a plurality of mechanically stable positions, a patient can be very effectively treated from all sides of his body. The open, interrupted structure of the lying arrangement and of the securing arrangement enables high accessibility to the patient, whereby the treatment process is additionally facilitated. In addition, the open structure not only allows effective cleaning of the patient, but also thorough cleaning of the conveying device itself, whereby, in the case of an accident involving a hazardous material, contamination carry-over can be avoided as best as possible.

It goes without saying that the constructional embodiment of the lying arrangement and of the securing arrangement and also of the support frame in particular can deviate from the embodiment shown in the exemplary embodiments, without departing from the scope of the disclosure. The type and shape of the undercarriage and of the wheels arranged thereon can of course also differ.

What is claimed is:

1. A stretcher for patients who are heavily soiled or are chemically, biologically or radioactively contaminated, comprising:
a bowl-shaped lying arrangement, which extends substantially along a longitudinal direction and has a lying surface for receiving a patient lying substantially along the longitudinal direction;
a securing arrangement for securing the patient on the lying arrangement;
a support frame, which is configured to allow the stretcher to be rolled on a ground surface between at least two mechanically stable positions about an axis of rotation arranged parallel to the longitudinal direction;
wherein the support frame comprises a first set-down element for setting down the stretcher on the ground surface in a first mechanically stable position, wherein the lying surface is oriented substantially parallel to the ground surface, and
wherein the support frame comprises at least one further set-down element for setting down the stretcher on the ground surface in at least one further mechanically stable position, wherein said at least one further mechanically stable position, compared to the first mechanically stable position, is rotated about the axis of rotation, wherein the lying surface is oriented transversely with respect to the ground surface.

2. The stretcher as claimed in claim 1, wherein the lying arrangement has a plurality of openings.

3. The stretcher as claimed in claim 1, wherein the support frame defines at least one curved surface portion, which is curved about the axis of rotation and which is configured to allow the stretcher to be rolled.

4. The stretcher as claimed in claim 3, wherein the support frame defines at least two planar surface portions, wherein a first planar surface portion is oriented parallel to the lying surface and forms the first set-down element, and wherein a second planar surface portion is oriented transversely to the lying surface and forms the at least one further set-down element.

5. The stretcher as claimed in claim 4, wherein the at least one curved surface portion and the at least two planar surface portions define an outer shell of the stretcher, and wherein the lying surface is spaced apart from the outer shell.

6. The stretcher as claimed in claim 1, wherein the stretcher together with a patient that is positioned on the lying surface has, depending on a body weight of said patient, a center of gravity that lies in a region around or on the axis of rotation.

7. The stretcher as claimed in claim 1, wherein the lying arrangement comprises side walls, which are oriented transversely with respect to the lying surface.

8. The stretcher as claimed in claim 1, wherein the securing arrangement comprises at least one grip for displacing the securing arrangement between an open position making the lying arrangement accessible, and a closed position, in which the securing arrangement holds a patient positioned on the lying surface with defined play.

9. The stretcher as claimed in claim 8, wherein said at least one grip in the open position prevents the stretcher from being rolled, and, in the closed position, forms the at least one further set-down element.

10. The stretcher as claimed in claim 1, wherein the securing arrangement has a plurality of resilient retaining elements that are spaced from one another along the longitudinal direction and are differently sized.

11. The stretcher as claimed in claim 1, further comprising an undercarriage with at least one wheel or a castor arranged thereon, wherein the undercarriage is arranged foldably on the lying arrangement.

12. A stretcher for patients, comprising:
a lying arrangement, which extends substantially along a longitudinal direction and has a lying surface for receiving a patient lying substantially along the longitudinal direction;
a securing arrangement for securing the patient on the lying arrangement;
a first set-down element, which is configured to allow the stretcher to be set down on a ground surface in a first mechanically stable position, in which the lying surface is oriented substantially parallel to the ground surface; and
at least one further set-down element, which is configured to allow the stretcher to be set down on the ground surface in at least one further mechanically stable position, wherein said at least one further mechanically stable position, compared to the first mechanically stable position, is rotated about the longitudinal direction, wherein the lying surface is oriented transversely with respect to the ground surface;
wherein the securing arrangement comprises at least one grip for displacing the securing arrangement between an open position, in which the lying arrangement is accessible, and a closed position, in which the securing arrangement secures a patient positioned on the lying surface,
wherein said at least one grip in the open position prevents the stretcher from being rolled, and, in the closed position, forms the at least one further set-down element.

13. The stretcher as claimed in claim 12, further comprising a support frame, which is configured to allow the stretcher to be rolled on the ground surface between the first and the at least one further mechanically stable position about an axis of rotation that is arranged parallel to the longitudinal direction.

14. The stretcher as claimed in claim 13, wherein the first set-down element and the at least one further set-down element are part of the support frame.

15. A portable conveying device for patients, with:
a lying arrangement, which extends substantially along a longitudinal direction and has a lying surface for receiving a patient lying substantially along the longitudinal direction;
a securing arrangement for securing the patient on the lying arrangement;
a first set-down element, which allows the device to be set down on a ground surface in a first mechanically stable position, wherein the lying surface is oriented substantially parallel to the ground surface; and
at least one further set-down element, which allows the device to be set down on the ground surface in at least one further mechanically stable position, which, compared to the first mechanically stable position, is rotated about the longitudinal direction, wherein the lying surface in the at least one further mechanically stable position is oriented transversely with respect to the ground surface.

16. The portable conveying device as claimed in claim 15, further comprising a support frame, which is configured to allow the device to be rolled on the ground surface between the first and the at least one further mechanically stable position about an axis of rotation that is arranged parallel to the longitudinal direction.

17. The portable conveying device as claimed in claim 16, wherein the first set-down element and the at least one further set-down element are part of the support frame.

18. The portable conveying device as claimed in claim 16, wherein the support frame defines at least one curved surface portion and at least two planar surface portions, wherein the at least one curved surface portion is curved about the axis of rotation and is configured to allow the device to be rolled, wherein a first of the at least two planar surface portions is oriented parallel to the lying surface and forms the first set-down element, and wherein a second of the at least two planar surface portions is oriented transversely to the lying surface and forms the at least one further set-down element.

19. The portable conveying device as claimed in claim 15, wherein the securing arrangement comprises at least one grip for displacing the securing arrangement between an open position, in which the lying arrangement is accessible, and a closed position, in which the securing arrangement secures a patient positioned on the lying surface, wherein said at least one grip in the open position prevents the device from being rolled, and, in the closed position, forms the at least one further set-down element.

20. The portable conveying device as claimed in claim 15, wherein the at least one further set-down element includes a second and a third set-down element, wherein the second set-down element is configured to allow the device to be set down on the ground surface in a second mechanically stable position, and the third set-down element is configured to allow the device to be set down on the ground surface in a third mechanically stable position, wherein the device may be set down in the second or the third mechanically stable position by rotating the device starting from the first mechanically stable position by 90° in clockwise direction or by 90° in counter-clockwise direction, respectively, about an axis of rotation that is arranged parallel to the longitudinal direction, wherein the lying surface is oriented in both the second and the third mechanically stable position perpendicularly with respect to the ground surface.
